(19) United States
(12) Patent Application Publication
(10) Pub. No.: US 2016/0321116 A1
(43) Pub. Date: Nov. 3, 2016

(54) TRANSLATING OPERATING SYSTEM PROCESSES

(71) Applicant: Microsoft Technology Licensing, LLC, Redmond, WA (US)

(72) Inventors: James A. Schwartz, Jr., Seattle, WA (US); Arun Kishan, Kirkland, WA (US); Nicholas S. Judge, Bellevue, WA (US); Stephen Hufnagel, Snohomish, WA (US); Yevgeniy M. Bak, Redmond, WA (US); Mehmet Iyigun, Kirkland, WA (US); Jeffrey B. Kay, Bellevue, WA (US); Cory Hendrixson, Sammamish, WA (US); Jonathan Wiswall, Woodinville, WA (US); Edward S. Miller, Kirkland, WA (US)

(73) Assignee: Microsoft Technology Licensing, LLC, Redmond, WA (US)

(21) Appl. No.: 14/752,215

(22) Filed: Jun. 26, 2015

Related U.S. Application Data
(60) Provisional application No. 62/154,537, filed on Apr. 29, 2015.

(51) Int. Cl. G06F 9/54; G06F 9/50

(52) U.S. Cl. CPC G06F 9/541; G06F 9/5011

(57) ABSTRACT

Various systems and methods for translating operating system processes are described herein. In one example, a method includes intercepting a process of a foreign operating system through a proxy driver. The method can also include translating the process to a native operating system within which the foreign operating system is operating. Furthermore, the method can include sharing memory between the native operating system and the foreign operating system for translation.

### CROSS-REFERENCE TO RELATED APPLICATION

The present application claims the benefit of U.S. Provisional Patent Application Ser. No. 62/154,537 by Schwartz et al., which is entitled “Translating Operating System Processes” and was filed Apr. 29, 2015, the contents of which is incorporated herein by reference as though fully set forth herein.

### BACKGROUND

Computing devices can be programmed to perform any number of functions based on a particular operating system installed. An operating system (OS) may include software that manages computer resources such as hardware and software associated with the computing device.

In some cases, a given OS may function differently than a different OS. Therefore, it may be difficult for applications configured to run in one OS to be installed and run on a second OS. Similarly, an application platform may encounter difficulty when applications configured to run on one application platform are to be installed and run on a second application platform.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

An embodiment provides a method for translating operating system processes. The method includes intercepting a process of a foreign operating system through a proxy driver. The method can also include translating the process to a native operating system within which the foreign operating system is operating. Furthermore, the method can include sharing memory between the native operating system and the foreign operating system for translation. The method can also include providing a target for various native operating system components to interact with a foreign application configured to run on the foreign operating system.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of an example of a computing system that can translate operating system processes;

FIG. 2 is a block diagram illustrating a bus configured to bridge a foreign process to a native operating system;

FIG. 3 is a flow diagram of a foreign process being translated to a native process;

FIG. 4 is a block diagram illustrating a method for translating operating system processes; and

FIG. 5 is a block diagram of an example computer-readable storage media for translating operating system processes.

### DETAILED DESCRIPTION

As discussed above, in some cases a given application is to run in a given operating system (OS). In other words, a computing device having an OS locally installed may not be able to run an application designed to run on a foreign OS. The techniques described herein include a proxy driver configured to enable a local OS (referred to herein as a native OS) to run processes of an application configured to run in a foreign OS.

The techniques described herein enable binaries of a foreign OS to run on a native OS. For example, the techniques described herein may include a runtime that enables applications (also referred to as “applications” herein) written for the Android® OS to run on the native OS 122. In this scenario, Android® is a foreign OS with respect to the native OS 122. The techniques described herein include running native binaries on a non-native OS. For example, in the techniques described herein, a binary of a foreign OS can run natively on a native OS without recompilation or source code changes.

The example techniques employ a user-mode dependency free process, which, as used herein, refers to a process with no user-mode dependencies paired with a kernel mode proxy driver that manages the process. In effect, user-mode dependency free processes are “naked processes” where the paired proxy driver(s) handle all user-mode to kernel-mode transitions including syscalls and exceptions. While the native OS handles paging and scheduling directly, the paired pico drivers provide access to the kernel services.

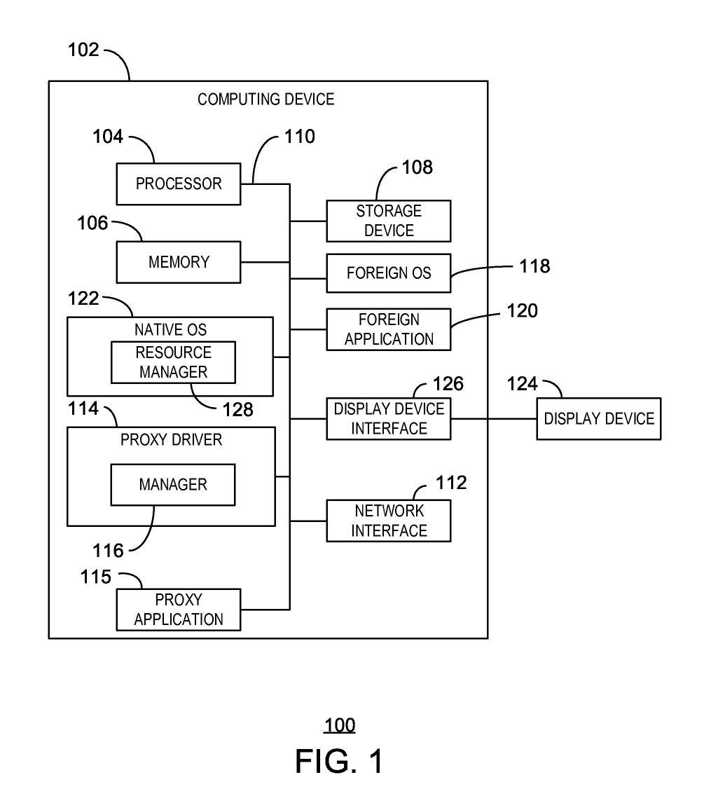

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not computer-readable storage media) may additionally include communication media such as transmission media for wireless signals and the like.

FIG. 1 is a block diagram of an example of a computing system that can translate OS processes. The computing system 100 may include a computing device 102 that may be, for example, a mobile phone, laptop computer, desktop computer, or tablet computer, among others.

The computing device 102 may include a processor 104 that is adapted to execute stored instructions, as well as a memory unit 106 that stores instructions that are executable by the processor 102. The memory unit 106 may be non-persistent memory in relation to a storage device 108 that may include a hard disk drive for example. The processor 104 can be a single core processor, a multi-core processor, a computing cluster, or any number of other configurations. The memory unit 106 can include random access memory (e.g., static random access memory (SRAM), dynamic random access memory (DRAM), zero capacitor RAM, Silicon-Oxide-Nitride-Oxide-Silicon SONOS, embedded DRAM, extended data out RAM, double data rate (DDR) RAM, resistive random access memory (RRAM), parameter random access memory (PRAM), etc.), read only memory (ROM) (e.g., Mask ROM, programmable read only memory (PROM), erasable programmable read only memory (EPROM), electrically erasable programmable read only memory (EEPROM), etc.)), flash memory, or any other suitable memory systems. The instructions executed by the processor 104 may be used in device resource enumeration. The processor 104 may be connected through a system bus 110 (e.g., Peripheral Component Interconnect (PCI), Industry Standard Architecture (ISA), PCI-Express, NuBus, etc.) to network interface 112.

The storage 108 can include a hard drive, an optical drive, a Universal Serial Bus (USB) flash drive, an array of drives, or any combinations thereof. A proxy driver 114 may be, in some cases, executable instructions to be stored in the storage device 108. In some cases, the proxy driver 114 may be implemented as logic, at least partially comprising hardware logic. The proxy driver 114 may include a manager 116. Although FIG. 1 illustrates the manager 116 as being a component of the proxy driver 114, the manager 116 may be implemented as a discrete component, or as a component of a broader process, or logical hardware construct.

The proxy driver 114 is configured to intercept a process of a foreign OS 118 having an application 120 and translate the process to a native OS 122. The proxy driver 114 is further configured to proxy driver 114 is further configured to be the intermediate between the native OS 122 and the foreign OS 118 for physical hardware access. For example, the application 120 may perform calls requiring memory allocation and the proxy driver 1114 may implement the memory allocation for the application 120. In other words, the proxy driver 114 may be configured to emulate the foreign OS 118 such that the application 120 may run as if the application is running on the foreign OS 118 for which it is designed.

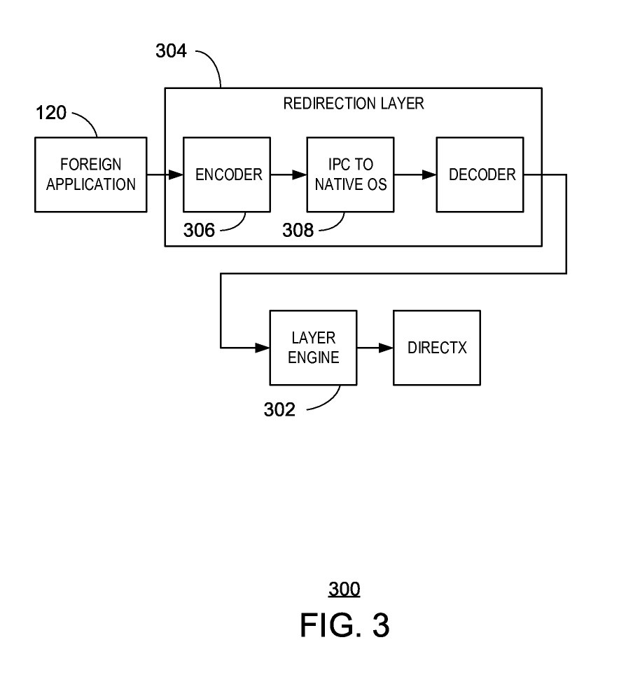

As discussed above, a memory allocation or a request to open a file may occur as a result of operations of the application 120. Memory allocation or requests to open a file may be handled by the proxy driver 114 by translating foreign OS 118 commands into native OS commands 122 and vice versa. As another example, the foreign OS 118 may be configured to run graphics commands in a first graphics protocol, while the native OS 122 may be configured to run graphics commands in a second graphics protocol. As discussed in more detail below in regard to FIG. 3, the proxy driver 114 may be configured to transform graphics calls in the foreign OS 118 to graphics calls associated with a graphics protocol of the native OS 122, such that images may be displayed at a display device 124 via a display interface 126 of the computing device 102.

The application 120 may be configured to operate only in the foreign OS 118. However, the proxy driver 114 may be configured to enable the application 120 to run in the native OS 122 by running the foreign OS 118 on top of a kernel mode driver, such as the proxy driver 114, emulating a kernel associated with the foreign OS 118. All user-mode to kernel transitions are intercepted by the proxy driver 114, including system calls and user-mode exceptions, allowing the proxy driver 114 to effectively emulate the kernel associated with the foreign OS 118. In emulating the kernel associated with the foreign OS 118, the proxy driver 114 leverages services exposed by the kernel associated with the native OS 122. In some cases, the kernel associated with the native OS 122 provides identical functionality to the kernel associated with the foreign OS 118 and the proxy driver 114 is a thin wrapper to the kernel service associated with the native OS 122. In other cases, the proxy driver 114 implements foreign OS 118 kernel functionality because similar functionality does not exist in the native OS 122 kernel, or the native OS 122 kernel implementation is sufficiently different from the foreign OS 118 kernel implementation.

The techniques described herein include pairing of native OS 122 processes with foreign OS 118 processes. For example, the native OS 122 may be a Windows® OS while the foreign OS 118 may be an Android® OS. In this case, pairing includes pairing Windows® processes with the Android® processes to facilitate the enablement of Windows® resource management, application lifetime and security on Android® applications. The paired Windows® processes may be referred to herein as “proxy processes” or as a “proxy application 115” carried about by the proxy driver 114. The Android® processes are referred to as “foreign processes” as they are foreign to the native OS 122. More generically, the techniques include the use of the proxy driver 114 to apply policy and policy mechanisms via the manager 116 on foreign processes that would not otherwise be managed with equivalent policy. In some cases, the usage of the proxy driver 114 may even allow techniques employed on one application model or OS (e.g., Windows® OS) to be applied to another application model or OS (e.g., Android® OS).

In some cases, the proxy driver 114 is an outer shell of the foreign application 120 and executes in a low privileged security context. The proxy driver 114 has a foreground task and one or more background tasks to provide connection points between the application 120 and the native OS 122. The native OS 122 proxy driver 122 on behalf of the foreign OS 118 application 120 for operations including context, sensors, audio, graphics, and the like may handle all requests for system services.

The proxy driver 114 may run in an application container with capabilities extracted from a manifest associated with the foreign OS 118 application 120. An application container may refer to any low privilege security container or context. This ensures that applications, such as the application 120 cannot access resources without triggering the normal native OS 122 capability checks. For example, requests for location information automatically ask the user for permissions.

The proxy driver 114 may also handle resource attribution via the manager 116. The processes associated with the application 120 and the proxy driver 114 may be bundled into a single management unit, called a native OS 122 container or management container, allowing native OS 122 resource management to work as normal, so resources consumed by the foreign OS 118 processes are reflected onto the proxy application 115 associated with the proxy driver 114. The proxy application 115 provides a target for various native OS 122 components to interact with the application 120 of the foreign OS 122. In this case, the idea is to attribute resources used by a foreign process associated with the foreign application 120 to the proxy application 115 with which the native OS 122 components know how to interact.

During a low memory situation, for example, a resource manager 128 associated with the native OS 122 may choose to terminate the proxy application 115 and the manager 116, which would also result in the termination of the foreign OS 118 processes the proxy driver 114 was managing via the manager 116. In some cases, the breadth of the proxy driver 114 includes management of a single application, such as the application 120. The concept of the proxy driver 114, however, may be extended to host multiple applications with resource management policies targeting a set of applications instead of a specific application.

Types of resource management policies that may be applied by the manager 116 may include application suspension, application terminate, application prelaunch, resource utilization limits, priority, outswap during suspension, memory compression at runtime, memory compression during suspend, security, and the like. Other resource management policies may be implemented including any combination of the management policies discussed herein.

When an application is not in active use, the application suspension policy may suspend the application 120 to minimize impact on user responsiveness and battery life. When the application 120 is suspended, none of the threads of the application 120 are runnable by a kernel thread scheduler. However, the state of the application 120 can remain resident in memory to minimize restart time if the application is resumed from suspension. Additional memory saving mechanisms can be applied when an application is suspended, including outswap and compression, which are described in more detail below. In some cases, the native OS 122 supports suspension in its application model, whereas the foreign OS 118 does not. In this scenario, the proxy application 115 may receive the native OS 122 lifecycle events and maps them to the closest equivalent in the foreign OS 118.

In application termination operations, the proxy application 115 provides the native OS 122 and management tools with a target for termination. When the proxy application 115 is terminated, an equivalent lifecycle event can be applied to the foreign OS 118 process(es). In application prelaunch operations, the native OS 122 may opportunistically prelaunch the application 120 in a background and put it into a suspended state in anticipation of a user's usage of the application 120. The pre-launching of the application 120 reduces the perceived application startup time, since it is already loaded in memory and initialized. The proxy driver 114 enables the application 120 to be similarly pre-launched, with the proxy application 115 starting the paired foreign OS 118 process and starting it in the background as well.

In resource utilization limits, an application model may restrict the resource utilization of the application 120 such as memory 106, processing power and availability of the processor 104, with differing limits based on usage associated with the application 120. For example, more resources may be provided when the user is directly interacting with the application 120 compared to when the application 120 is opportunistically doing work in the background. The proxy application 115 provides the native OS 122 and management tools 128 with a target for resource management and limiting resource utilization.

In addition to restricting the resource utilization of the application 120, an application model for the native OS 122 can manipulate the priority of access to resources for the application 120. With a priority-based thread scheduling, a thread priority associated with the application 120 can be modified to either prioritize or deprioritize its execution. Similar, inputs and outputs (I/O) associated with application 120 can be prioritized or deprioritized relative to other work. The application 120 can be prioritized when a user is actively interacting with the application 120. Conversely, the application 120 can be deprioritized when doing opportunistic work in the background. The proxy application 115 provides the native OS 122 and management tools 128 with a target for resource management and prioritization.

Outswap during suspend may refer to when the application 120 is suspended, and when no threads can execute in the application 120, its memory contents can be written to disk, such as storage 108, making the physical memory in the memory unit 106 available for other usage. Because sequential I/Os are generally faster than random I/Os, coupled with the application 120 already being in an initialized state, it may be faster to resume the application 120 outswapped to storage 108 than to cold launch the application 120. It is possible to outswap even if the application 120 is not suspended if there is little to no actively by the application 120. If activity is sufficiently low, the cost of paging some memory associated with the application 120 back in from storage 108 may be an acceptable trade-off to the memory in the memory unit 106 that becomes available for other usage when outswapping the application 120.

Memory compression at runtime may also be implemented as a policy. When the application 120 is running, the memory manager 128 may choose to trim its pages from the working set to reduce its active memory footprint. Private pages belonging to the application 120 can be compressed in memory unit 106 to reduce memory consumption and pagefile writing that can cause significant interference to foreground activity of this and other applications.

Memory compression during suspend may also be implemented as a policy. When the application 120 is suspended, since no threads can execute in the application 120, its memory contents can be compressed to make physical memory available for other usage. This technique can also be combined with outswap, writing compressed memory to disk.

Security may also be implemented as a policy. The application 120 runs in a low privilege context with capabilities extracted from the foreign application 120 manifest. This ensures that applications cannot access resources without triggering the native OS 122 capability checks. For example, requests for location information automatically ask the user for permissions.

Usage of Inter Process Communication (IPC) channels to tightly couple the proxy application 115 to a foreign process of the application 120 enable discovery of foreign process crashes. The proxy driver 114 and the foreign OS 118 processes may be tightly coupled through inter-process communication (IPC) channels. In one case, the channels may be implemented over a proprietary IPC mechanism. However, the IPC mechanism can be anything that allows bidirectional communication such as a socket or a file. In addition to the obvious benefit of communication between enlightened components in each process, the IPC channel additionally provides application lifecycle benefits. One notable benefit is the usage of the IPC channel to discover a crash and either take remediation to restart the crashed process or to exit gracefully.

Usage of Inter Process Communication (IPC) channel to support fast and efficient communication between native OS 122 and foreign processes of the application 120 on the same machine, such as the computing device 102, are described herein. Communication protocols exist across the native OS 122 and the foreign OS 118, enabling client/server communication across OS boundaries. In some cases, a cross-OS protocol may be built on top of a socket transport layer. Due to the unique environment where one OS is built on top of another, unique optimizations can be applied to the cross OS IPC. Specifically, the techniques described herein support the sharing of memory from one process to another, across the OS boundary. This can be leveraged in latent sensitive code paths to avoid an intermediate memory copy. Example usages include passing a graphics texture from a foreign process to the proxy driver 114 or passing a camera photo from the proxy driver 114 to a foreign process.

It is to be understood that the block diagram of FIG. 1 is not intended to indicate that the computing system 100 is to include all of the components shown in FIG. 1. Rather, the computing system 100 can include fewer or additional components not illustrated in FIG. 1 (e.g., additional applications, additional modules, additional memory devices, additional network interfaces, etc.). Furthermore, any of the functionalities of the proxy driver 114 may be partially or entirely implemented in hardware and/or in the processor 102. For example, the functionality may be implemented with an application specific integrated circuit, in logic implemented in the processor 102, or in any other device. Further, although references to specific operating systems such as the Windows® OS and the Android® OS, as well as specific services associated with the specific operating systems, are used below, the techniques described herein are not specific to any given OS and may be implemented in many other operating systems and associated services.

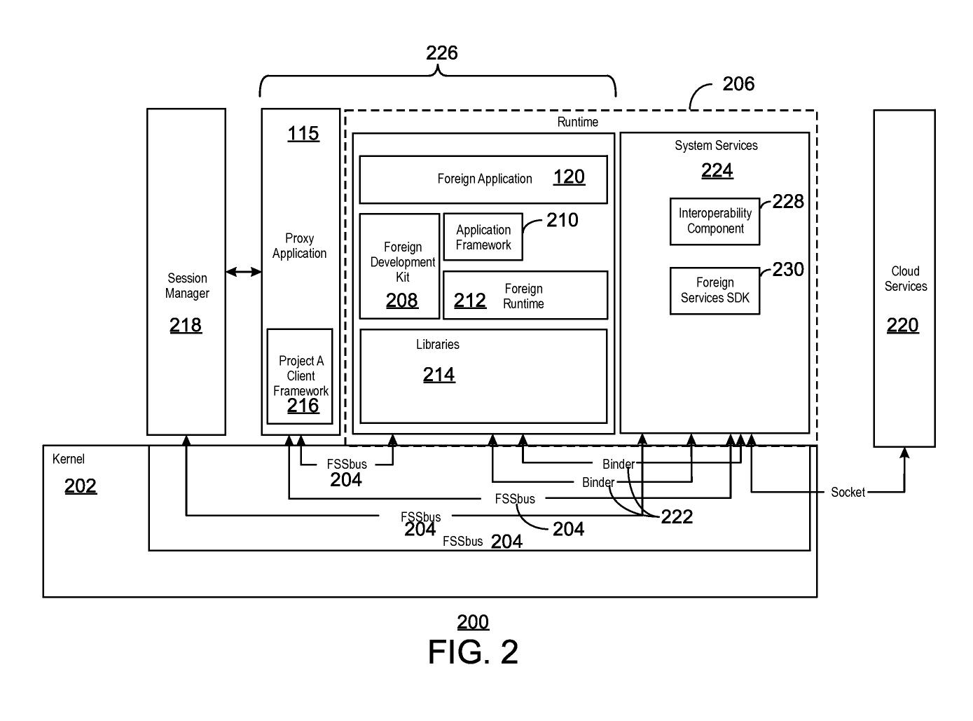

FIG. 2 is a block diagram illustrating a bus configured to bridge a foreign process to a native operating system. In some cases, a proxy driver, such as the proxy driver 114 may be viewed as a bus, such as a subsystem bus in a kernel layer 202 as illustrated in FIG. 2.

As discussed above, the techniques described herein enables foreign OS 118 binaries to run on the native OS 122 using user-mode dependency free process technology. A user-mode dependency free process is a process with no user-mode dependencies paired with a kernel mode driver, such as the proxy driver 114 (or set of drivers) that manages the process instead of a native OS 122 subsystem. In effect, user-mode dependency free processes are “naked processes” where the paired driver(s) handle all user-mode to kernel-mode transitions including system calls and exceptions. While the native OS 122 handles paging and scheduling directly, the paired drivers provide access to the kernel services.

The user-mode dependency free process driver, such as the proxy driver 114 of FIG. 1, is referred to in FIG. 2 as a Foreign Subsystem bus (FSSbus) 204. In FIG. 2, a runtime 206 may include the foreign application 120, a foreign development kit 208 native to the foreign OS 118, an application framework 210 associated with the foreign application 120, a foreign runtime 212, one or more libraries 214 associated with the foreign OS 118. The proxy application 115 may be running in a low privilege context as discussed above in regard to FIG. 1. The proxy application 115 may also be associated with a client framework 215 specific to a computing device such as the computing device 102 of FIG. 1. The proxy application may be configured to communicate with a session manager 218. The session manager 218 may be configured to manage the techniques described herein runtime.

Drivers, such as the proxy driver 114 FIG. 1, associated with the FSSbus 204 implement a system call interface and a collection of foreign OS 118 kernel services, providing a means to load and run foreign binaries. The proxy drivers 114 associated with the FSSbus 204 implement a namespace associated with the foreign OS 118, which includes mapping on-disk namespace into the native OS 122 file system. The FSSbus 204 also implements the in-memory portion of the namespace, commonly referred to as a Virtual File-System (VFS), which provides an alternative mechanism to achieve functionality of many system calls or an additional way to query and set kernel properties. Drivers, such as the proxy driver 114 of FIG. 1, associated with the FSSbus 204 may be split into a core, generic driver with a foreign OS 118 specific driver layered on top, allowing the core native driver to be re-used as a generic subsystem in the future.

Similar to a virtual machine, the FSSbus 204 may virtualize platform hardware. Network access to cloud services 220, for example, is provided directly through the FSSbus 204. The FSSbus 204 abstraction additionally allows on-disk foreign namespace to reside on a native formatted volume such that native support is not required for the foreign OS's 118 underlying file-system.

While the bulk of the system calls maybe generic, in some cases there are other foreign OS 118 specific kernel services that are also implemented in the FSSbus 204. For example, a binder 222 may be the foreign OS 118 inter-process communications (IPC) and remote procedure call (RPC) mechanism. The binder 222 may serve as the backbone for access to Android foreign OS 118 system services 224.

In some cases, the system services 224 may include advertising, analytics, location services, maps, authentication and many other services The foreign application 120 may use foreign services, which provides advertising, analytics, location services, maps, authentication and many other services. The in some cases, foreign services are not part of the public binaries. In some cases, the techniques described herein may provide an interoperability component 228 that offers matching services of the native OS 122 as replacement for services provided by the foreign OS 118.

The interoperability services provided by the interoperability component can be mapped for an application depending on which application programming interfaces (APIs) are used. For these applications, an interoperability software developer kit (SDK) provides access to the native OS 122 compatible services by mapping the native OS 122 services APIs directly to the foreign OS 118 API.

However, other services require changes to the application itself for proper support. For example, in-application purchases (IAP) may use JavaScript Object Notation (JSON) signed receipts while the native OS 122 services used signed Extensible Markup Language (XML). In this case, interoperability services are provided by a foreign service SDK 230. The foreign services SDK 230 provides access to all of the interoperability services with function signatures in a native OS 122 namespace that are identical to the foreign OS 118 APIs where possible and similar where not identical.

The libraries 214 from the foreign services SDK 230 may be added directly to an application package associated with the foreign application 120. Once installed, these libraries may access services directly in the cloud or via redirection to native APIs, much like the redirection services described previously. To assist, the foreign services SDK 230 may be configured to run in the proxy driver 114 runtime to broker access to device and cloud services.

The techniques described herein include support for running multiple applications concurrently, unlike typical foreign OS 118 on devices, primarily to support the proxy architecture, where each proxy is essentially a virtual display. In some cases, the foreign application 120 has minimal or no support for mouse and keyboard environments. The techniques described herein may enhance the foreign OS 118 in a way that makes it usable for desktop.

The runtime 206 is a fork of a platform associated with the foreign application 120 that is optimized to run on the native OS 118 using user-mode dependency free processes and the FSSbus 204. The runtime 206, once booted, is shared and all applications including the foreign application 120 run in the same instance, as indicated at 226.

The collection of processes running in the proxy driver 114 or FSSbus 204 runtime 206 are all user-mode dependency free processes, with one “exploded view” 200 of the user-mode dependency free process running the foreign application 120. Like the native OS 122, the foreign OS 118 operates with brokered access to hardware and services, requiring several background processes to be created when the system boots. In the “exploded view” 200, the foreign application runs in a user-mode dependency free process, loading all of the typical libraries and shared objects. Since the architecture described herein supports running native foreign binaries, foreign applications can be coded in Java or C++ (using the Native Development Kit) and still run successfully in the architecture runtime.

However, the code running in a user-mode dependency free process cannot access native hardware or services. As such, the foreign binaries may be modified to redirect any requests to specific native OS 122 services. This is enabled by a communications component in the FSSbus 204. In FIG. 2, FSSbus 204 provides a high performance messaging and shared memory interface between the proxy driver 114 runtime and the native OS 122. This interface is used for virtually all interaction between the foreign OS 122 and the native OS 122, including soft input panel (SIP)/keyboard, touch, graphics output, sensor and other hardware access, copy/past operations, and the like. Most of the communications may be handled via the FSSbus 204 since most of the operations require minimal data transfer. However, in some cases, graphics operations in particular take advantage of the shared memory interface to move large graphics buffers (textures, shaders) between the runtime and the native OS 122.

The redirection architecture leads to a runtime model where all foreign OS 118 applications run in at least two processes—one native proxy application 115 process and one or more foreign OS 118 processes. The native proxy application 115 is the outer shell of every foreign OS 118 application 120 and runs in an application container having a foreground task and one or more background tasks that provide the connection points between the foreign OS 118 application and the native OS 122. All requests for system services may be handled by the native proxy application 115 on behalf of the foreign OS 118 application including content, sensors, audio, graphics, and the like.

The proxy application 115 runs in an application container with capabilities extracted from the foreign application 120 manifest. This ensures that applications cannot access resources without triggering the normal native OS 122 capability checks. For example, requests for location information automatically ask the user for permission, so reliance on foreign OS 118's security models is minimized.

The proxy also handles resource attribution. The foreign application 120 user-mode dependency free processes and the proxy are bundled into a single job object, allowing native resource management to work as normal, so the resources consumed by the foreign OS 118 processes are reflected onto the proxy application 115. During a low memory situation, for example, the native resource manager may choose to terminate the proxy application 115, which would also result in the termination of the foreign OS 118 processes the proxy application 115 was managing.

In addition to the services provided by the proxy application 115, a few services may be provided by proxy on the system level. One example of this is network services, which defers all of the foreign OS 118 functionality to the native OS 122 for low-level routing setup, internet protocol address assignment, tethering, WiFi connectivity, and the like. These services are initiated from a foreign OS 118 system component in the system services 224 and are routed to a system proxy.

FIG. 3 is a flow diagram of a foreign process being translated to a native process. Foreign application 120 may be configured to use OpenGL graphics. To run on the native OS 122, OpenGL calls are transformed into DirectX calls using a layer engine associated with the native OS 122. The techniques described herein, a layer engine is a component of the native proxy. Foreign application 120 may compose user interface (UI) elements using OpenGL, but instead of being handled by a native foreign OS 118 OpenGL driver, the OpenGL calls may be captured and encoded by a redirection layer 304 including an encoder 306, an IPC, and a decoder 310. The encoded OpenGL calls are then sent to the native proxy via the FSSbus 204 where they are decoded and sent through the layer engine 302 to be rendered by DirectX 312. FSSbus 204 facilitates the sometimes-large data transfers (textures, shaders) with a shared memory facility ensuring good graphics performance.

Other device accesses may also be redirected through the proxy application 115. The foreign OS 118 hardware abstraction layer (HAL) was heavily modified to ensure that an application's context is preserved such that requests to a device could be directed to the correct proxy. This preserves the functionality of the proxy's application container and ensures permission checks are properly done in the native OS 122.

The techniques described herein applications are delivered to the device as APPXs, just like any other store app. In some cases, users are not necessarily told that the application 120 is a proxy driven application, nor should it matter that it is. The key components of the proxy driver 114 APPXs are the start-up stub executable (which launches the native proxy) and the foreign OS 118 APK payload. When a foreign application 120 is downloaded from a store, its installation is managed with a special handler that extracts the APK from the APPX and kicks off a separate installation process in the proxy driver 114 runtime by calling a proxy driver 114 package manager. This is the foreign OS 118 installation counterpart to the native APPX installation. Once that installation is successful, the APPX installation completes and a tile shows up on the user's device.

Orchestration of the connections between native proxies and foreign application 120 may be handled by a component called the Running Application Table (RAT). The RAT is a service running in the proxy driver 114 runtime 206 (not a native service) that provides the rendezvous point for foreign application 120 to connect to native proxies.

In some cases, when the user taps on the tile for a proxy driver 114 supported application, the stub executable launches the native proxy. The proxy driver 114 registers with the RAT. The RAT then establishes a communications channel between the system IntentRedirector and the native proxy. The native proxy then issues a launch intent for the foreign OS 118 application it represents to launch the foreign OS 118 app. Once the foreign OS 118 application is launched, the RAT coordinates setting up the redirection channels between the foreign application 120 and the proxy application 115.

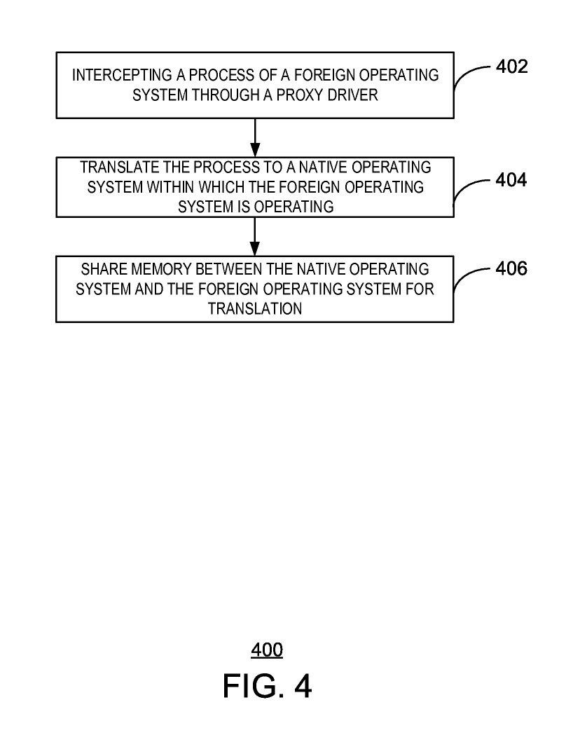

FIG. 4 is a block diagram illustrating a method for translating operating system processes. At block 402, the method 400 includes intercepting a process of a foreign operating system through a proxy driver. At block 404, the method 400 includes translating the process to a native operating system within which the foreign operating system is operating, and at block 406, the method includes sharing memory between the native operating system and the foreign operating system for translation.

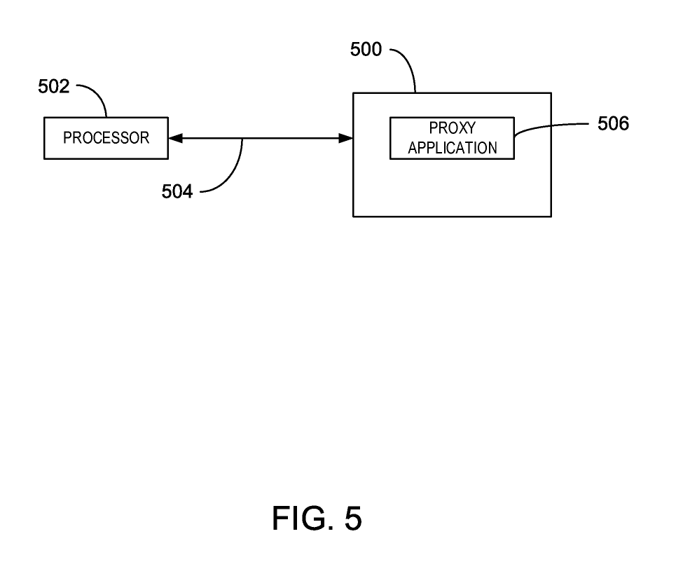

FIG. 5 is a block diagram of an example computer-readable storage media for translating operating system processes. The tangible, computer-readable storage media 500 may be accessed by a processor 502 over a computer bus 504. Furthermore, the tangible, computer-readable storage media 500 may include code to direct the processor 502 to perform the steps of the current method.

The various software components discussed herein may be stored on the tangible, computer-readable storage media 500, as indicated in FIG. 5. For example, the tangible computer-readable storage media 500 can include a proxy application 506. The proxy application may be configured to intercept a process of a foreign operating system through a proxy driver, translate the process to a native operating system within which the foreign operating system is operating, and share memory between the native operating system and the foreign operating system for translation.

It is to be understood that any number of additional software components not shown in FIG. 5 may be included within the tangible, computer-readable storage media 500, depending on the specific application. Although the subject matter has been described in language specific to structural features and/or methods, it is to be understood that the subject matter defined in the appended claims is not necessarily limited to the specific structural features or methods described above. Rather, the specific structural features and methods described above are disclosed as example forms of implementing the claims.

Although many examples have illustrated how foreign application 120 may be executed on a Windows platform, it will be recognized that the teachings herein may also be applied to executing Windows applications on a foreign OS 118 platform. In addition, the teachings herein can also be applied to other combinations of application running on foreign OSs including, for example, Android, Mac OS, Solaris, FreeBSD, Google Chrome OS, Open Suse, Ubuntu, and the like. In other words, the techniques described herein may be applied to any OS wherein a foreign OS application runs on the original OS.

Example 1 is a system for translating operating system processes. The wireless charging device may include a native operating system, a foreign operating system, and a proxy driver configured to intercept a process of the foreign operating system and translate the process to the native operating system. The proxy driver may be configured to be an intermediate between the native operating system and the foreign operating system for physical hardware access, and a proxy application to provide a target for various native operating system components to interact with a foreign application configured to run on the foreign operating system.

Example 2 includes the system of example 1. In this example, intercepting and translation are implemented by running binaries of the foreign operating system on the native operating system.

Example 3 includes the system of any combination of examples 1-2. In this example, the proxy driver is configured to emulate the foreign operating system within the native operating system.

Example 4 includes the system of any combination of examples 1-3. In this example, the proxy driver is a kernel mode driver of the native operating system.

Example 5 includes the system of any combination of examples 1-4. This example includes pairing the process of the foreign operating system with a process of the native operating system.

Example 6 includes the system of any combination of examples 1-5. In this example, the proxy application configured to manage foreign processes associated with the foreign application.

Example 7 includes the system of any combination of examples 1-6. In this example, the management of the foreign application associated with the foreign operating system comprising: application lifecycle, resource management, security, or any combination thereof.

Example 8 includes the system of any combination of examples 1-7. In this example, the proxy driver and proxy application are to apply native security policies and resource management to the foreign operating system.

Example 9 is a method for translating operating system processes. The method may include intercepting a process of a foreign operating system through a proxy driver, translating the process to a native operating system within which the foreign operating system is operating, and sharing memory between the native operating system and the foreign operating system for translation.

Example 10 includes the method of any combination of examples 1-9. In this example, intercepting and translation are implemented by running binaries of the foreign operating system on the native operating system.

Example 11 includes the method of example 11. This example includes emulating the foreign operating system within the native operating system via the proxy driver. The proxy driver is a kernel mode driver of the native operating system.

Example 12 includes the method of example 11. This example includes applying a same performance optimization as well as lifecycle management features to a foreign application running in the foreign operating that are applied to a native application running in the native operating system.

Example 13 includes the method of any combination of examples 11-12. In this example, the method includes pairing the process of the foreign operating system with a process of the native operating system.

Example 14 includes the method of any combination of examples 11-13. This example includes managing an application associated with the foreign operating system via the proxy driver.

Example 15 includes the method of any combination of examples 11-14. In this example, management of the application associated with the foreign operating system comprising: application lifecycle, resource management, security, or any combination thereof.

Example 16 includes the method of any combination of examples 11-15. In this example, the method includes implementing an inter-process communication without recording data related to the operation and associated with each operating system separately.

One or more computer-readable storage devices for storing computer-readable instructions that, when executed by one or more processing devices, cause the one or more processing devices to intercept a process of a foreign operating system through a proxy driver. The computer-readable instructions that, when executed by one or more processing devices, cause the one or more processing devices to translate the process to a native operating system within which the foreign operating system is operating, and share memory between the native operating system and the foreign operating system for translation.

Example 18 includes the one or more computer-readable storage media of any combination of examples 11-17. In this example, intercepting and translation are implemented by running binaries of the foreign operating system on the native operating system.

Example 19 includes the one or more computer-readable storage devices of any combination of examples 11-18, in which the computer-readable instructions, when executed by the one or more processing devices, cause the one or more processing devices to emulate the foreign operating system within the native operating system via the proxy driver.

Example 20 includes the one or more computer-readable storage devices of any combination of examples 11-19. In this example, the proxy driver is a kernel mode driver of the native operating system.

Example 21 includes the one or more computer-readable storage devices of example 21, in which the computer-readable instructions, when executed by the one or more processing devices, cause the one or more processing devices to pair the process of the foreign operating system with a process of the native operating system.

Example 22 includes the one or more computer-readable storage devices of example 21, in which the computer-readable instructions, when executed by the one or more processing devices, cause the one or more processing devices to manage an application associated with the foreign operating system via the proxy driver.

Example 23 includes the one or more computer-readable storage devices of any combination of examples 21-22, in which the management of the application associated with the foreign operating system may include application lifecycle, resource management, security, or any combination thereof.

Example 24 includes the one or more computer-readable storage devices of any combination of examples 21-23, in which the computer-readable instructions, when executed by the one or more processing devices, cause the one or more processing devices to apply native security policies and resource management to the foreign operating system.

1. A system for translating operating system processes, comprising:
a native operating system;
a foreign operating system;
a proxy driver configured to intercept a process of the foreign operating system and translate the process to the native operating system, the proxy driver being configured to be an intermediate between the native operating system and the foreign operating system for physical hardware access; and
a proxy application to provide a target for various native operating system components to interact with a foreign application configured to run on the foreign operating system.

2. The system of claim 1, wherein intercepting and translation are implemented by running binaries of the foreign operating system on the native operating system.

3. The system of claim 1, the proxy driver being configured to emulate the foreign operating system within the native operating system.

4. The system of claim 1, the proxy driver being a kernel mode driver of the native operating system.

5. The system of claim 1, further comprising pairing the process of the foreign operating system with a process of the native operating system.

6. The system of claim 1, the proxy application configured to manage foreign processes associated with the foreign application.

7. The system of claim 6, the management of the foreign application associated with the foreign operating system comprising:
application lifecycle;
resource management;
security; or
any combination thereof.

8. The system of claim 1, comprising applying native security policies and resource management to the foreign operating system.

9. A method for translating operating system processes, comprising:
intercepting a process of a foreign operating system through a proxy driver;
translating the process to a native operating system within which the foreign operating system is operating; and
sharing memory between the native operating system and the foreign operating system for translation.

10. The method of claim 9, wherein intercepting and translation are implemented by running binaries of the foreign operating system on the native operating system.

11. The method of claim 9, further comprising emulating the foreign operating system within the native operating system via the proxy driver, wherein the proxy driver is a kernel mode driver of the native operating system.

12. The method of claim 9, further comprising applying a same performance optimization as well as lifecycle management features to a foreign application running in the foreign operating that are applied to a native application running in the native operating system.

13. The method of claim 9, further comprising pairing the process of the foreign operating system with a process of the native operating system.

14. The method of claim 9, further comprising managing an application associated with the foreign operating system via the proxy driver.

15. The method of claim 14, the management of the application associated with the foreign operating system comprising:
application lifecycle;
resource management;
security; or
any combination thereof.

16. The method of claim 9, comprising implementing an inter-process communication without recording data related to the operation and associated with each operating system separately.

17. One or more computer-readable storage devices for storing computer-readable instructions that, when executed by one or more processing devices, cause the one or more processing devices to:
intercept a process of a foreign operating system through a proxy driver;
translate the process to a native operating system within which the foreign operating system is operating; and
share memory between the native operating system and the foreign operating system for translation.

18. The one or more computer-readable storage media of claim 17, wherein intercepting and translation are implemented by running binaries of the foreign operating system on the native operating system.

19. The one or more computer-readable storage devices of claim 17, in which the computer-readable instructions, when executed by the one or more processing devices, cause the one or more processing devices to emulate the foreign operating system within the native operating system via the proxy driver.

20. The one or more computer-readable storage devices of claim 17, the proxy driver being a kernel mode driver of the native operating system.

21. The one or more computer-readable storage devices of claim 17, in which the computer-readable instructions, when executed by the one or more processing devices, cause the one or more processing devices to pair the process of the foreign operating system with a process of the native operating system.

22. The one or more computer-readable storage devices of claim 17, in which the computer-readable instructions, when executed by the one or more processing devices, cause the one or more processing devices to manage an application associated with the foreign operating system via the proxy driver.

23. The one or more computer-readable storage devices of claim 22, in which the management of the application associated with the foreign operating system comprises:
application lifecycle;
resource management;
security; or
any combination thereof.

24. The one or more computer-readable storage devices of claim 17, in which the computer-readable instructions, when executed by the one or more processing devices, cause the one or more processing devices to apply native security policies and resource management to the foreign operating system.
